(19) United States
(12) Patent Application Publication
(10) Pub. No.: US 2024/0205272 A1
(43) Pub. Date: Jun. 20, 2024

(54) Cloud-Based Datacenter Management Systems and Methods

(71) Applicant: Edify Labs, Inc., Fishers, IN (US)

(72) Inventors: Cameron Weeks, Santa Monica, CA (US); Bracken Fields, Santa Monica, CA (US); Aron Droege, Santa Monica, CA (US); Jon Sparks, Santa Monica, CA (US); Mathew Altepeter, Santa Monica, CA (US)

(21) Appl. No.: 18/544,311

(22) Filed: Dec. 18, 2023

Related U.S. Application Data
(60) Provisional application No. 63/476,369, filed on Dec. 20, 2022.

(51) Int. Cl. H04L 65/1073; H04L 65/1069; H04L 67/1001

(52) U.S. Cl. CPC H04L 65/1073; H04L 65/1069; H04L 67/1001

(57) ABSTRACT

Cloud-based datacenter management systems and methods are disclosed. Embodiments include methods implemented by the cloud computing system and by clients served by the cloud computing system. Example cloud based computing systems include an application server and a plurality of session servers. Some embodiments include after the application server has received a request to establish a communication session with a client, determining a set of two or more session servers with which the client has an active registration. Then, for each session server of the set of two or more session servers with which the client has an active registration, determining a response time between the client and the session server. And then establishing the communication session with the client via the session server having the shortest response time of the set of two or more session servers with which the client has an active registration.

### CROSS-REFERENCE TO RELATED APPLICATIONS

This application claims priority to U.S. Provisional App. 63/476,369, titled “Datacenter Management,” filed on Dec. 20, 2022, and currently pending. The entire contents of U.S. Provisional App. 63/476,369 are incorporated herein by reference.

### SUMMARY

Systems and methods disclosed herein relate to dynamic datacenter management, including dynamic management on a per-application basis and/or on a per-transaction basis. In some embodiments, the datacenter is implemented as a cloud computing system comprising one or more application servers and a plurality of session servers.

In operation, the session servers are configured to perform several tasks in connection with facilitating communication sessions for clients served by the cloud computing system, including but not limited to registering clients with session servers, initiating communication sessions applications provided by the cloud computing system (e.g., via an application server and/or the session servers), managing communication sessions (including facilitating the transfer of communication sessions between and among session servers in some scenarios), and terminating communication sessions.

As disclosed herein, a client includes a hardware computing device (e.g., a laptop computer, desktop computer, smartphone, tablet computer, smartwatch, or any other type of computing device now known or later developed) and/or a software application running on a hardware computing device. The communication sessions facilitated by the session servers support applications implemented by the client devices, such as file transfers, database queries, remote desktop services, streaming media, interactive sessions (e.g., voice, messaging, video), or any other type of application now known or later developed.

One aspect of the disclosed systems and methods is that individual clients maintain an active registration with several different session servers concurrently.

In some embodiments, the cloud computing system (e.g., via the application server or a session management server) maintains a registration table (e.g., a database, table, or similarly suitable data structure) that includes a listing of each client's active registrations with the session servers in the cloud computing system. In some instances, the registration table also includes, for each active registration, a signaling response time between the client and the session server corresponding to the active registration.

In operation, a new entry is added to the registration table when a client registers with a session server. For example, when the cloud computing system receives a registration request from a client, the cloud computing system (e.g., via the application server or a session management server for the cloud computing system) evaluates response times to determine suitable session servers for that client to register with. In some embodiments, a client sends a registration request as part of connecting to the cloud computing system. In some embodiments, a client may send a registration request to the cloud computing system if one or more operational metrics associated with one or more active registrations falls below a preconfigured threshold.

When a client has active registrations with more than one session server, communication sessions can be initiated and maintained in some instances via the session server that is best able to facilitate the communication session for a particular application.

Some embodiments include the cloud computing system establishing a communication session for a client. In operation, the cloud computing system may establish a communication session for a client in several scenarios, including scenarios where the client is the initiating entity or the target entity. In some contexts, the initiating entity is sometimes referred to as a calling party and the target entity is sometimes referred to as the called party. When the client is the target entity, the initiating entity may be (i) another client served by the cloud computing system or (ii) a computing device or application that is not served by the cloud computing system, but rather, a computing device or application that sends the request to the cloud computing system via the Internet. Similarly, when the client is the target entity, the initiating entity may be (i) another client served by the cloud computing system or (ii) a computing device or application that is not served by the cloud computing system but is reachable via the Internet. Thus, in some scenarios, one client served by the cloud computing system may be the initiating entity, and a different client served by the cloud computing system may be the target entity.

In some scenarios when establishing a communication session for a client as the target entity (sometimes referred to as the target client for ease of explanation), the cloud computing system determines each session server with which the target client has an active registration. In some instances, determining the session servers with which the target client has active registrations includes querying a registration table at an application server, session management server, or other network-connected computing device or system suitable for storing a registration table and providing active registration data to requesting computing devices/systems in response to queries or requests for active registration data.

After identifying the session servers with which the target client has an active registration, a response time between the target client and each session server is determined. In some instances, the registration table includes current response times between the target client and each session server with which the target client has an active registration. In other instances, the response time between the target client and each session server (with which the target client has an active registration) is measured via signaling between each session server and the target client. After the response times are determined, the communication session is established with the client via the session server having the shortest response time of all the session servers with which the client has an active registration.

In some embodiments, each session server with which the target client has an active registration sends a session setup request to the target client, and the target client responds to the first session request that it receives. After the target client responds to the first request that it receives, the target client ignores (or perhaps declines) the later-arriving session setup request(s), and the communication session with the target client is established via the session server that sent the first-arriving session setup request.

In some scenarios when establishing a communication session for a client as the initiating entity (sometimes referred to as the initiating client for ease of explanation), the initiating client (or a session manager application running on the initiating client) determines a response time between the initiating client and each session manager with which the initiating client has an active registration, and the communication session is established via the session server having the fastest response time.

In some embodiments, the initiating client sends a session setup request to each session server with which the initiating client has an active registration. In some instances, the first session server to receive the setup request from the initiating client both (i) responds to the initiating client and (ii) informs the other session servers with which the initiating client has an active registration that it (i.e., the first responding session server) will facilitate the communication session with the initiating client so that the other session servers can ignore (or perhaps decline) any later-arriving session set up request received from the initiating client. In other instances, each session server responds to the session setup request received from the initiating client, thereby causing the initiating client to receive responses from each session server with which it (the initiating client) has an active registration. In some such scenarios, the communication session is established with the session server that sent the first-arriving response, and the initiating client ignores (or perhaps declines) the later-arriving response(s) received from the other session server(s).

After establishing the communication session, and while the communication session is active, some embodiments additionally include monitoring one or more performance metrics of the communication session. If one or more of the monitored performance metrics exceed a corresponding configured threshold(s), the communication session may be transitioned to a different session server that also has an active registration for the client, thereby enabling optimization of communication session performance and load balancing across the session servers.

### BRIEF DESCRIPTION OF FIGURES

FIG. 1 shows an example of a typical datacenter implementation.

FIG. 2 shows an example of a datacenter implementation according to some embodiments.

FIG. 3A shows aspects of an example computing server suitable for performing aspects of the disclosed methods according to some embodiments.

FIG. 3B shows aspects of an example client suitable for performing aspects of the disclosed methods according to some embodiments.

FIG. 4 shows aspects of an example method according to some embodiments.

FIG. 5 shows aspects of an example method according to some embodiments.

### DETAILED DESCRIPTION OF THE FIGURES

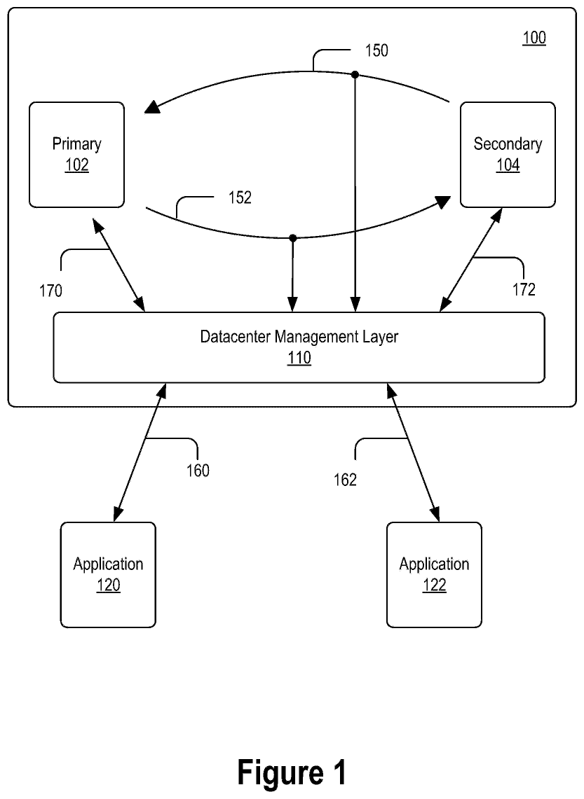

FIG. 1 shows an example of a typical datacenter implementation 100.

Datacenter implementation 100 includes (i) a primary data server 102, (ii) a secondary data server 104, sometimes referred to as a backup data server, and (iii) data center management layer 110.

The components of datacenter implementation 100 are generally distributed over a wide geographic area. For example, the primary data server 102 may be in a first geographic location, and the secondary data server 104 may be in a second geographic location different than the first geographic location.

In operation, primary data server 102 and secondary data server 104 synchronize their data between each other and exchange data relating to their respective operational status with each other and with data center management layer 110 via links 150 and 152.

While the primary data server 102 is the “active” data server, the primary data server 102 processes transactions on behalf of applications (e.g., application 120 and application 122) while the secondary data server 104 is in a “standby” mode (and does not actively process transactions).

If and/or when the primary data server 102 experiences some operational failure (or perhaps some significant operational degradation), then the second data server 104 takes over from the primary data server 102 to become the “active” data server. While the secondary data server 104 is the “active” data server, the secondary data server 104 processes transactions on behalf of applications (e.g., application 120 and application 122) while the primary data server 102 is in a “standby” mode (and does not actively process transactions).

Examples of applications include, but are not limited to, file transfers, database queries, remote desktop services, streaming media, interactive sessions (e.g., voice, messaging, video), or any other type of application now known or later developed. Transactions include transmitting and/or receiving data related to an application. For ease of illustration, a computing terminal running an application is sometimes referred to herein simply as an application. In some instances, a terminal (e.g., any type of computing device or computing system now known or later developed) may run several applications at the same time. A computing terminal in some instances may be referred to as a client or a client device.

Datacenter management layer 110 determines how to route transactions to the primary data server 102 and/or the secondary data server 104 based on the operational status of the primary data server 102 and the secondary data server 104.

For example, when primary data server 102 is the “active” data server (and the secondary data server 104 is the “standby” data server), the datacenter management layer 110 (i) facilitates transactions 160 between application 120 and the primary data server 102 by routing data corresponding to the transactions 160 via link 170, and (ii) facilitates transactions 162 between application 122 and the primary data server 102 by routing data corresponding to the transactions 162 via link 170.

But when a failure or other problem causes the secondary data server 104 to take over from the primary data server 102 to become the “active” data server in datacenter implementation 100, then the datacenter management layer 110 (i) facilitates transactions 160 between application 120 and the secondary data server 104 by routing data corresponding to the transactions 160 via link 172 and (ii) facilitates transactions 162 between application 122 and the secondary data server 104 by routing data corresponding to the transactions 162 via link 172.

One drawback with the typical datacenter implementation 100 shown in FIG. 1 is that sometimes the primary data server 102 may be fully operational, but an application is not able to communicate with the primary data server 102 for some reason.

For example, application 120 may not be able to communicate with primary data server 102 because of a network problem, a computing resource problem, or other operational degradation. Alternatively, communications between application 120 and the primary data server 102 may become degraded as compared to normal operation because of some network or other operational problem.

However, application 120 may still be able to communicate with secondary data server 104 because the network problem preventing application 120 from communicating with the primary data server 102 (or perhaps degrading communications and/or database transaction processing between application 120 and the primary data server 102) may not affect communications (or transaction processing) between application 120 and the secondary data server 104.

But because the datacenter management layer 110 component determines which of the primary data server 102 or secondary data server 104 should process transactions on behalf of applications (including applications 120 and 122), and because the primary data server 102 is generally operational, the datacenter management layer 110 may nevertheless attempt to route the transactions 160 for application 120 to the primary data server 102. As a result, application 120 may be unable to complete transactions, and/or application 120 may experience degraded performance of its transactions 160.

### A. EXAMPLE CLOUD BASED SYSTEM CONFIGURATION

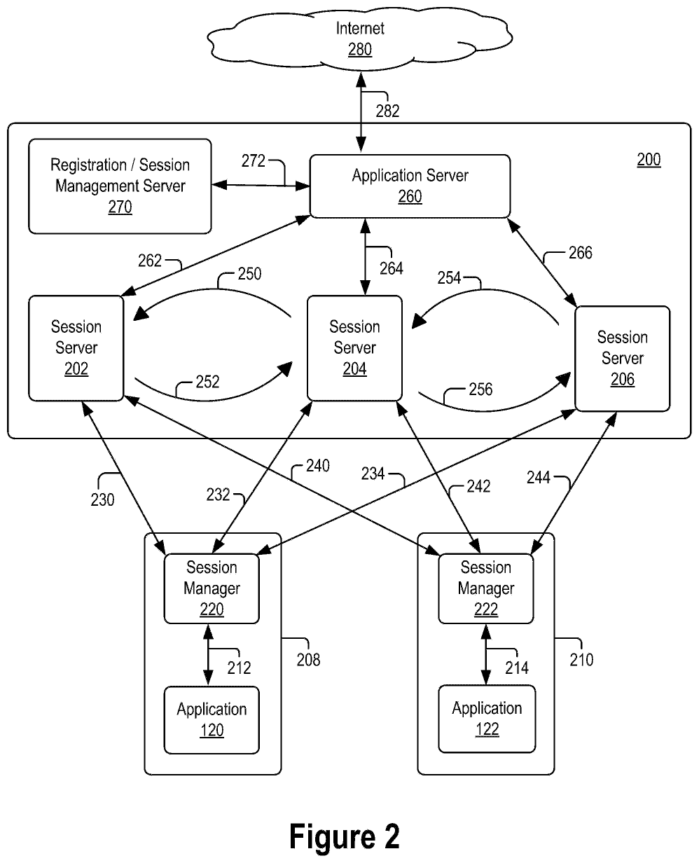

FIG. 2 shows an example of a cloud-based system 200 according to some embodiments to overcome or at least ameliorate some drawbacks of typical datacenter implementations like the example shown in FIG. 1.

In operation, the cloud-based system 200 is configured to provide network-based applications to individual clients (e.g., client 208 and client 210), or in some instances to individual applications running on the clients, via (i) an application server 260, (ii) a registration/session management server 270, and (iii) two or more session servers, shown as session server 202, session server 204, and session server 206. The network-based applications provided by the cloud-based system 200 include any network-based application, including but not limited to, file transfers, database queries, remote desktop services, streaming media, interactive sessions (e.g., voice, messaging, video), or any other type of network-based application now known or later developed. In operation, network-based applications are provided by one or more application servers (e.g., application server 260) via communication sessions that are established and/or managed by the session servers 202, 204, 206, individually or in combination with one or both of the session servers 202, 204, 206 and/or the registration/session management server 270 in some instances.

The application server 260, registration/session management server 270, and session servers 202, 204, and 206 are shown as separate components for ease of illustration. In some embodiments, one or more features described as being performed by one of the application server 260, registration/session management server 270, or session servers 202, 204, and 206 may instead be performed by another of the application server 260, registration/session management server 270, or session servers 202, 204, and 206.

For instance, one or more functions described herein as being performed by the application server 260 may instead be performed by one of the session servers 202, 204, 206, or the registration/session management server 270, individually or in combination with each other. Likewise, one or more functions described herein as being performed by the registration/session management server 270 may instead be performed by the application server 260 or one of the session servers 202, 204, 206, individually or in combination with each other. Similarly, one or more functions described herein as being performed by one of the session servers 202, 204, 206 may instead be performed by the application server 260 or the registration/session management server 270, individually or in combination with each other.

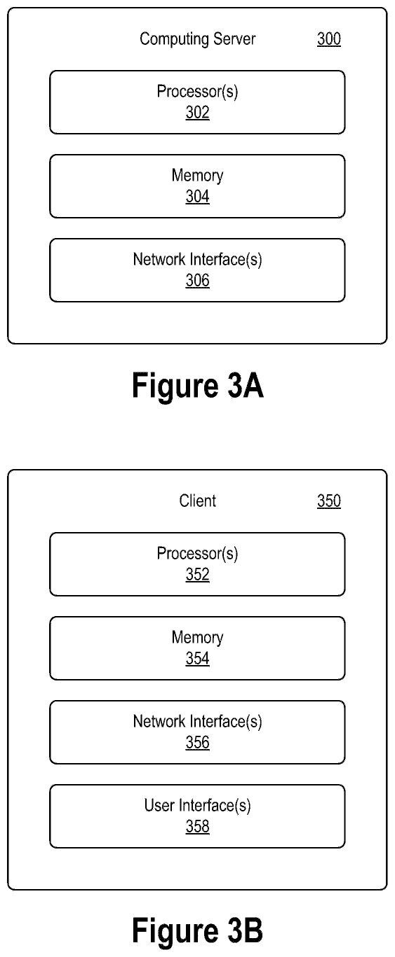

The application server 260 is configured to support one or more network-based applications. In some embodiments, cloud-based system 200 may include several application servers configured to support several different applications. Some embodiments may include several application servers configured to support a single application. In some instances, supporting an application includes, but is not limited to, processing, transmitting, and/or receiving data related to the application. Processing, transmitting, and/or receiving data related to the application is sometimes referred to herein as processing application transactions. The application server 260 may be implemented by one or more computing servers such as computing server 300 shown and described with reference to FIG. 3A.

The registration/session management server 270 is configured to support aspects of managing communication sessions as disclosed herein, including in some instances, maintaining one or more registration tables containing information about active registrations and perhaps metrics associated with the registrations. In connection with maintaining one or more registration tables containing information about active registrations and perhaps metrics associated with the registrations, the registration/session management server 270 is configured to exchange data relating to maintaining one or more registration tables containing information about active registrations and perhaps metrics associated with the registrations via link 272 with one or both of (i) application server 260 and (ii) the session servers 202, 204, and 206.

For example, in some embodiments, the registration/session management server 270 maintains an active registration response time table that includes, for each active registration between a client and a session server, a current response time between the client and the session server. In some embodiments, the response time is based on any one or more of network latency between the client and the session server, network latency between the application server and the session server, or processing time at the session server.

The registration/session management server 270 may be implemented by one or more computing servers such as computing server 300 shown and described with reference to FIG. 3A. In some embodiments, the session severs 202, 204, and 206 are located at different geographic locations. In other embodiments, a single geographic location may include more than one session server.

An individual session server is configured to support aspects of (i) setting up, maintaining, and/or terminating client registrations, (ii) setting up, managing, transitioning, and/or terminating communication sessions, (iii) determining how to route transactions for applications in some instances, and (iv) other session server features disclosed herein.

In some embodiments, the session server may also perform one or more (or all) of the functions of the application server for a client (or the application running on the client) after a communication session between the session server and the client has been established for that client. In this respect, the session server (instead of or in addition to the application server) may perform processing, transmitting, and/or receiving data related to the application. Processing, transmitting, and/or receiving data related to the application is sometimes referred to herein as processing application transactions. An individual session server may be implemented by one or more computing servers such as computing server 300 shown and described with reference to FIG. 3A.

Some embodiments may include just two session servers rather than the three shown in cloud-based system 200. Other embodiments may include more than three session servers. Typically, session server 202, session server 204, and session server 206 are located in different geographical locations. However, in some instances, one or more of session server 202, session server 204, and session server 206 may be co-located at a single geographic location.

In some embodiments, session server 202, session server 204, and session server 206 synchronize at least some data between each other and exchange at least some data relating to their respective operational status with each other via links 250, 252, 254, and 256. In operation, the data exchanged between and among the session server 202, session server 204, and session server 206 includes, but is not necessarily limited to, (i) information relating to the clients that have active registrations with the individual session servers 202, 204, and 206, and (ii) data corresponding to the state and status of individual communication sessions and/or applications implemented via the plurality of session servers 202, 204, and 206. In some instances, the session servers 202, 204, and 206 additionally exchange operational, status, and/or substantive application data with one or both of the application server 260 and/or registration/session management server 270 via links 262, 264, and 266.

As mentioned above, the computing devices in cloud-based system 200 are configured to provide network-based applications to individual clients (e.g., client 208 and client 210), or in some instances to individual applications running on the clients.

FIG. 2 shows two clients (208 and 210) for illustration purposes. In operation, a typical commercial deployment consistent with example cloud-based system 200 would provide network-based applications to hundreds or even thousands of clients (or applications running on clients).

In the example shown in FIG. 2, client 208 is running application 120 and includes a session manager 220, which is arranged to communicate with the application 120 via link 212 (which is typically internal to the client 208). Similarly, client 210 is running application 122 and includes a session manager 222, which is arranged to communicate with application 122 via link 214 (which is typically internal to the client 210). Client 208 and client 210 may be the same as or similar to client 350 shown and described with reference to FIG. 3B.

Application 120 running on the client 208 (and application 122 running on client 210) can be any type of network-based application, including but not limited to, a file transfer application, a database client application, a remote desktop application, a streaming media application, an interactive communication application (e.g., voice, messaging, video), or any other type of network-based application now known or later developed. In some instances, application 120 and application 122 may be the same application, e.g., application 120 and application 122 may both be interactive voice communication applications. In other instances, application 120 and application 122 may be different applications, e.g., application 120 may be a remote desktop service and application 122 may be a an interactive video communication application.

The example shown in FIG. 2 shows client 208 running single application 120 and client 210 running single application 122 for illustration purposes. In operation, however, client 208 and client 210 may run several different applications concurrently. For example, client 208 may run a remote desktop service and an interactive video communication application at the same time.

In addition to the applications, each client also runs one or more session managers. In the example illustrated in FIG. 2, client 208 runs session manager 220 and client 210 runs session manager 222.

In some embodiments, each application running on the client has its own corresponding session manager that maintains one or more active registrations for the client corresponding to the application. For example, in some embodiments where client 208 is running two applications (e.g., a remote desktop application and an interactive video application), client 208 may have a first session manager for the first application (e.g., the remote desktop application) and a second session manager for the second application (e.g., the interactive video session).

In some such embodiments, each session manager at the client maintains a separate registration with one or more session servers for each application. Continuing the example where the client 208 has a first session manager for a first application (e.g., the remote desktop application) and a second session manager for a second application (e.g., the interactive video application), the first session manager establishes and maintains a first set of one or more active registrations for the first application (e.g., the remote desktop application) with one or more of the session servers 202, 204, and 206, and the second session manager establishes and maintains a second set of one or more active registrations for the second application (e.g., the interactive video application) with one or more of the session servers 202, 204, and 206.

In other embodiments, a client may have one session manager for several applications running on the client. For example, if the client 208 is running a first application (e.g., the remote desktop application) and a second application (e.g., the interactive video application), in some such embodiments, the session manager 220 at client 208 establishes and maintains (i) a first set of one or more active registrations for the first application (e.g., the remote desktop application) with one or more of the session servers 202, 204, and 206, and (ii) a second set of one or more active registrations for the second application (e.g., the interactive video application) with one or more of the session servers 202, 204, and 206. In some instances, the individual session servers of the cloud computing system 200 are configured to support multiple applications. In other instances, the session servers support a single application. In scenarios where the client is able to support several different applications and the individual session servers support a single application, the session manager(s) at the client may manage many active registrations with many different session servers. For example, for each application, the session manager may manage several active registrations with corresponding session servers.

Rather than establishing and maintaining separate sets of active registrations (i.e., a separate set of active registrations for each application) as described above, the session manager in some embodiments may instead maintain a single set of active registrations with one or more of the session servers 202, 204, and 206, and all of the applications running on the client may use the same common set of active registrations. For example, if the client 208 is running a first application (e.g., the remote desktop application) and a second application (e.g., the interactive video application), in some such embodiments, the session manager 220 at client 208 establishes and maintains a set of one or more active registrations with one or more of the session servers 202, 204, and 206, and both applications (e.g., the remote desktop application and the interactive video application) may use the same active registrations with the same one or more session servers.

The active registrations are used for establishing communication sessions with session servers for use in processing transactions for applications provided by the cloud computing system 200 via the session servers 202, 204, and 206.

In some embodiments, the session manager 220 for the client 208 (or for the application(s) 120 running on the client 208): (i) manages active registrations for the client 208 (or the application(s) 120) with at least one or more (preferably two or more) of the session servers 202, 204, 206; (ii) when the client 208 has two or more active registrations with two or more of the session servers session servers 202, 204, 206, determines which of the two or more session servers 202, 204, 206 via which to establish communication sessions that will be used for processing transactions for the application 120; and (iii) whether to transition from using a first communication session via a first session server to using a second communication session via a second session server based on operational and/or performance metrics of the first communication session, and if so, managing the transition from the first communication session to the second communication session.

For example, in some embodiments, the session manager 220 at client 208 maintains an active registration for client 208 with each of (i) the session server 202, (ii) the session server 204, and (iii) the session server 206. Similarly, session manager 222 at client 210 maintains an active registration for client 208 with each of (i) the session server 202, (ii) the session server 204, and (iii) the session server 206.

For example, in some embodiments, when client 208 connects to the cloud-based system 200, the client 208 sends a registration request (or inquiry) to the cloud computing system 200. In some instances, the client 208 sends the registration request to at least one of the application server 260, the registration/session management server 270, or another suitable server configured to process and respond to registration inquiries received from clients.

After receiving the registration inquiry from a client, the cloud computing system 200 determines at least one (preferably two or more) candidate session servers for the client to establish an active registration with.

For example, with respect to client 208, in some embodiments, determining at least one (and preferably two or more) candidate session servers for the client 208 to establish an active registration with includes, (i) for each of a plurality of available session servers 202, 204, 206 in the cloud computing system 200, determining a response time between the available session server and the client 208 (i.e., determining a response between (a) client 208 and session server 202, (b) client 208 and session server 204, and (c) client 208 and session server 206), (ii) including available session servers having a determined response time below a threshold response time in the set of two or more candidate session servers, and (iii) excluding any available session server having a determined response time above the threshold response time from the set of two or more candidate session servers. In some embodiments, the threshold response time is one of (i) less than about 250 ms, (ii) less than about 500 ms, (iii) less than about 750 ms, or (iv) less than about 1 second.

For instance, if the measured response times between the client 208 and session servers 202, 204, and 206 are 300 ms, 700 ms, and 1.2 seconds, respectively, and the threshold response time is 750 ms, then session servers 202 and 204 would be included in the set of two or more candidate session servers (because they had response times below the threshold), and session server 206 would be excluded from the set of two or more candidate session servers (because it had a response time above the threshold).

After determining the set of candidate session servers, some embodiments include the cloud computing system 200 sending the client an identification of each candidate session server. Continuing with the example where the candidate session servers for client 208 include session server 202 and 204, the cloud computing system 200 sends client 208 an indication of session servers 202 and 204. In operation, the indication includes information sufficient information about each candidate session server so that the client 208 can send a registration request to each candidate session server. After client 208 receives the set of candidate session servers (i.e., session servers 202 and 204), or perhaps in response to receiving the set of candidate session servers, client 208 sends a registration request to each candidate session server in the set of candidate session servers, i.e., client 208 sends a registration request to session server 202 and session server 204.

After session server 202 receives the registration request from client 208, or perhaps in response to receiving the registration request from client 208, session server 202 creates an active registration for client 208. Similarly, after session server 204 receives the registration request from client 208, or perhaps in response to receiving the registration request from client 208, session server 204 also creates an active registration for client 208.

In some embodiments that include a registration/session management server 270, information about the newly created active registrations is provided by the session servers 202 and 204 to the registration/session management server 270 and/or the application server 260 via links 262 and 264. In some examples, the information about the active registrations for the client 208 includes, but is not limited to, for each active registration, one or more (or all) of: (i) the date/time that the registration was created, (ii) the client and session server for the registration, (iii) the application(s) associated with the registration, (iv) the communication session(s) (if any) that have been established, (v) the measured response time(s) between the client and the session server, which may be updated over time, (vi) historical response times and/or response time trends (e.g., whether measured response times have been trending upward or downward over some duration of time), (vii) performance metrics of communication sessions associated with the registration, and/or (viii) other information about the registration, the client, the session server, and communication sessions associated with the registration that may be used and/or useful for monitoring and managing registrations. Some embodiments may additional include, at each session server in the set of two or more session servers with which the client has an active registration, renewing the active registration with the client on a periodic or semi-periodic basis.

In operation, the information about the active registrations maintained by the registration/session management server 270 is used in connection with setting up new communication sessions to support applications executed by the clients that are hosted by the cloud computing system 200.

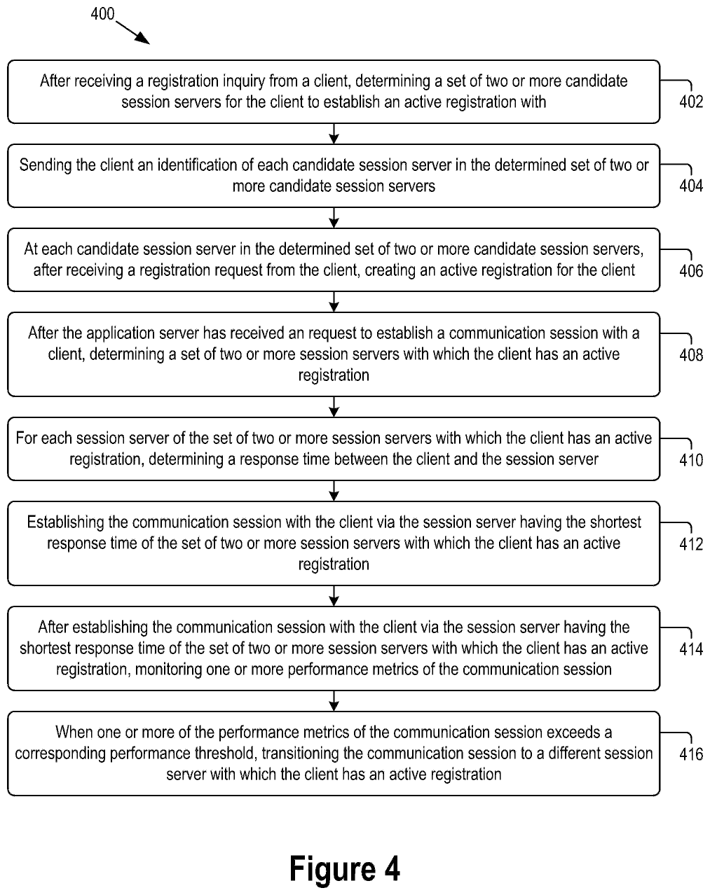

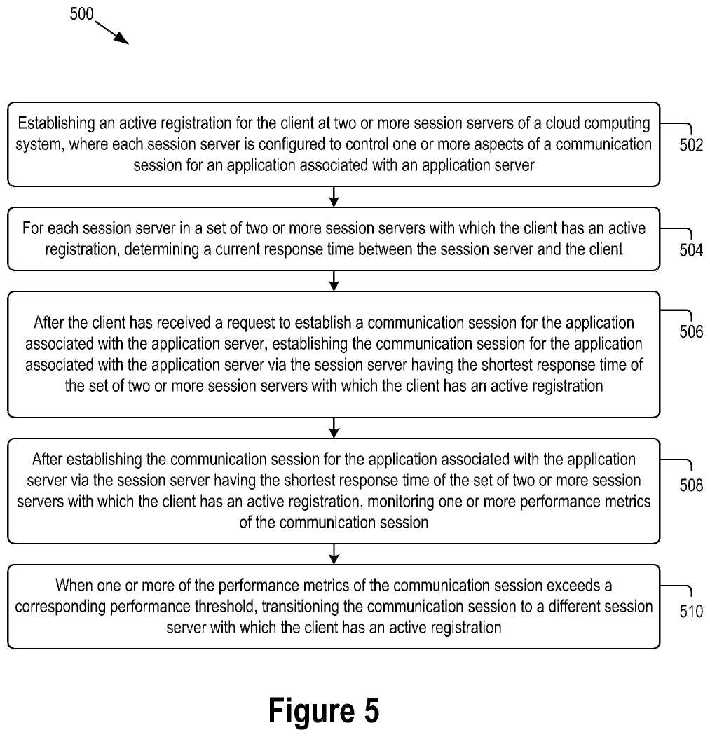

In the example shown in FIG. 2, session manager 220 at client 208 has an active registration with each of session server 202, 204, and 206. When the client 208 starts a new application (e.g., application 120), the session manager 220 at the client 208, individually or in combination with the application server 260, determines which session server with which to establish a communication session to exchange transactions for the application 120, e.g., via the processes described with reference to FIGS. 4 and 5. When the client 208 is exchanging transactions for the application 120 via a communication session with session server 202, the client 208 and the session server 202 exchange transactions via link 230. Similarly, when the client 208 is exchanging transactions for the application 120 via a communication session with session server 204, the client 208 and the session server 204 exchange transactions via link 232. And when the client 208 is exchanging transactions for the application 120 via a communication session with session server 206, the client 208 and the session server 206 exchange transactions via link 234.

Further, in the example shown in FIG. 2, session manager 222 at client 210 has an active registration with each of session server 202, 204, and 206. When the client 210 starts a new application (e.g., application 122), the session manager 222 at the client 210, individually or in combination with the application server 260, determines which session server with which to establish a communication session to exchange transactions for the application 122, e.g., via the processes described with reference to FIGS. 4 and 5. When the client 210 is exchanging transactions for the application 122 via a communication session with session server 202, the client 210 and the session server 202 exchange transactions via link 240. Similarly, when the client 210 is exchanging transactions for the application 122 via a communication session with session server 204, the client 210 and the session server 204 exchange transactions via link 242. And when the client 210 is exchanging transactions for the application 122 via a communication session with session server 206, the client 210 and the session server 206 exchange transactions via link 244.

After a communication session for an application has been established, some embodiments include monitoring the performance of the communication session.

In some instances, the session manager at the client can choose to route or otherwise process transactions for an application via any of the session servers with which the client has an active registration based on the operational status of each session server both (i) at the time that a communication session for an application is started or (ii) on a moment-by-moment basis while the communication session for the application is active. In some embodiments, the session servers 202, 204, and 206 share application state information and transaction information with each other so that each of the session servers 202, 204, and 206 know the state of the active registrations, the state of (and perhaps operational metrics of) established communication sessions, and in some instances, metrics for individual transactions via the established communication sessions. Although sharing such a great amount of data between and among the session servers can greatly increase the network bandwidth and computing resources required for the cloud computing system 200, sharing this level of data between and among the session servers can improve the overall availability and reliability of the network-based applications provided by the cloud computing system 200.

Accordingly, in some embodiments where a client (e.g., client 208) may have active registrations at session server 202, session server 204, and session server 206, and where the client 208 may currently be sending/receiving transactions for an application via an established communication session with session server 202, the session manager 220 at client 208 (or perhaps the session server 202) may determine that one of the other session servers 204, 206 may be able to provide better performance.

For example, if client 208 is exchanging transactions for application 120 via a communication session with session server 202 over link 230 and the operational performance of the communication session begins to degrade (e.g., because of network congestion on link 230 or because of processing delays at session server 202), session manager 220 (or session server 202) may determine that application 120 may perform better (e.g., faster response times, better transaction speed, lower delay, and so on) with a different session server with which the client 208 has an active registration (e.g., session server 204). In such a scenario, session manager 220, individually or in combination with session server 202 and/or session server 204, may establish a new communication session with session server 204. And after the new communication session has been established with session server 204, the client 208 starts exchanging transactions for application 120 via the new communication session with session server 204.

In some instances, the session manager 220 may maintain the first communication session with session server 202 and the second communication session with session server 204 concurrently for some period of time, and during that period of time, exchange some transactions for application 120 with session server 202 and exchange other transactions for application 120 with session server 204. By monitoring the operational status of each of the session servers 202, 204, and 206, the session manager 220 can choose the best session server with which to initiate and maintain communication sessions via for processing individual transactions for application 120 at any given moment in time while application 120 is running on client 208.

In operation, a session manager may monitor several different aspects of the operation of the individual session servers, including but not limited to communications status (e.g., reachable or not reachable), network load, processor load, transaction backlog, historical transaction times, network latency, network congestion, changes in network latency and/or congestion over time, changed in network and/or processor load over time, and changes in transaction backlog over time, individually or in combination with any other operational networking and/or processing metric now known or later developed that would be suitable for determining whether to route individual transactions between an application and an individual session server.

By configuring each of the session servers 202, 204, and 206 to process transactions from applications, and by distributing transaction routing decision making to individual session managers at the clients for individual applications, the example cloud-based system 200 provides improved performance for individual applications running on clients as compared to the traditional datacenter implementation 100 shown in FIG. 1 at least in part by determining how to route individual transaction data between applications and available session servers in a real-time or substantially real-time manner.

### B. EXAMPLE COMPUTING SERVERS AND CLIENTS

FIG. 3A shows aspects of an example computing server 300 that is suitable for performing aspects of the disclosed methods according to some embodiments.

Computing server 300 includes one or more processors 302, tangible, non-transitory computer-readable memory 304, and one or more network interfaces 306.

The one or more processors 302 may be any type of processor suitable for executing program instructions to perform various functions of the computing server 300. In some embodiments, the one or more processors 302 comprise any one or more central processing units (CPUs), graphics processing units (GPUs), and/or any other type of processor now known or later developed that is suitable for executing program instructions for performing computing server functions.

The tangible, non-transitory computer-readable memory 304, may be any type of computer storage media now known or later developed that is suitable for storing program instructions for execution by the one or more processors 302 and storing data collected and/or used by the computing server 300 to perform the various functions of the computing server 300. In some embodiments, the tangible, non-transitory computer-readable memory 304 includes any one or more random access memory (RAM), read-only memory (ROM), flash memory, disk drives, and/or any other type of suitable computer memory.

The network interfaces 306 may be any type of network interface now known or later developed that is suitable for exchanging data between and among the computing server 300 and other devices via personal area networks (PAN), local area networks (LAN), wide area networks (WAN), and/or the Internet. Examples include Ethernet, Bluetooth, Zigbee, Firewire, Thunderbolt, Wi-Fi, cellular data interfaces, and/or any other type of suitable network interface.

In operation, example computing server 300 may be configured to perform the functions of any of the session servers 202, 204, 206, the application server 260, the registration/session management server 270, or in some instances, the clients 208, 210. For example, the computing server 300 may be configured to perform various tasks performed by any of any of the session servers 202, 204, 206, the application server 260, the registration/session management server 270, or in some instances, the clients 208, 210, including but not limited to managing communication sessions, determining response times between clients and servers, processing registration requests, monitoring performance metrics, processing data for the network-based applications provided by the cloud computing system 200, or any of the other features performed by the cloud computing system 200.

FIG. 3B shows aspects of an example client 350 suitable for performing aspects of the disclosed methods according to some embodiments. Examples of clients include, but are not limited to, smartphones, tablet computers, smartwatches, laptop computers, desktop computers, thin client terminal devices, computer servers, voice assistants (e.g., similar to Amazon Alexa or Google Home devices), smart televisions, smart speakers, gaming consoles, Internet of Things (IoT) devices, or any other computing device now known or later developed that is suitable for running network-based applications provided by a cloud computing system.

The client 350 includes one or more processors 352, tangible, non-transitory computer-readable memory 354, one or more network interfaces 356, and, at least in some instance, one or more user interfaces 358.

The one or more processors 352 may be any type of processor suitable for executing program instructions to perform various functions of the client 350. In some embodiments, the one or more processors 302 comprise any one or more central processing units (CPUs), graphics processing units (GPUs), and/or any other type of processor now known or later developed that is suitable for executing program instructions for performing client functions.

The tangible, non-transitory computer-readable memory 354, may be any type of computer storage media now known or later developed that is suitable for storing program instructions for execution by the one or more processors 352 and storing data collected and/or used by the client 350 to perform the various functions of the client 350. In some embodiments, the tangible, non-transitory computer-readable memory 354 includes any one or more random access memory (RAM), read-only memory (ROM), flash memory, disk drives, and/or any other type of suitable computer memory.

The network interfaces 356 may be any type of network interface now known or later developed that is suitable for exchanging data between and among the client 350 and other devices via personal area networks (PAN), local area networks (LAN), wide area networks (WAN), and/or the Internet. Examples include Ethernet, Bluetooth, Zigbee, Firewire, Thunderbolt, Wi-Fi, cellular data interfaces, and/or any other type of suitable network interface

The user interfaces 358 may be any type of user interface now known or later developed that is suitable for receiving inputs from a user of the client 350 or otherwise enabling the user to interact with the client 350. Examples include, but are not limited to (i) graphical user interface (GUI), such as windows, icons, menus, pointer device for interaction, etc. typically found on desktop/laptop computers, smartphones, tablets, and the like, (ii) touchscreen interfaces implemented on a display screen that enable a user to interact with the client 350 by touching the display screen, such as on smartphones and tablets via gestures like swiping, pinching, tapping, and the like, (iii) command line interfaces (CLI) the enable a user to type commands to perform actions, commonly found on desktop/laptop operating systems and also in web browsers, (iv) natural user interfaces (NUI) such as voice interfaces that enable users to interface with the client 350 via voice commands and questions, and motion-based interfaces that use cameras to track user movements and gestures, (v) physical buttons, switches, sliders, or similar physical interfaces, and/or (vi) virtual reality (VR) interfaces such as VR headsets and related VR accessories that enable a user to interact with the client 350 via tracking eye movements, head movement, hand movements, or other interactions with a virtual interface. Hardware components to support the above-listed user interfaces include, but are not limited to, for example, a display/monitor, touchscreen, keyboard, mouse, microphone, speakers, switches/buttons/sliders, VR headset, or any other suitable user interface device now known or later developed that is suitable for enabling a user to interact with the client 350, and the network-based applications running on the client 350 provided by the cloud computing system 200.

### C. EXAMPLE METHODS

FIG. 4 shows aspects of an example method 400 according to some embodiments. In some embodiments, method 400 is performed by one or more components of a cloud computing system, such as any one or more of an application server 260, registration/session management server 270, and/or session server 202, 204, 206, individually or in combination with each other.

Method 400 begins at step 402, which includes after receiving a registration inquiry from a client (e.g., client 208 or client 210), determining a set of two or more candidate session servers for the client to establish an active registration with.

In some embodiments, determining a set of two or more candidate session servers for the client to register with at step 402 includes (i) for each of a plurality of available session servers in the cloud computing system, determining a response time between the available session server and the client, (ii) including available session servers having a determined response time below a threshold response time in the set of two or more candidate session servers; and (iii) excluding any available session server having a determined response time above the threshold response time from the set of two or more candidate session servers. In operation, the response time may be based on any one or more (or all) of network latency between the client and the session server, network latency between the application server and the session server, or processing time at the session server.

Next, method 400 advances to step 404, which includes sending the client an identification of each candidate session server in the determined set of two or more candidate session servers.

Next, method 400 advances to step 406, which includes at each candidate session server in the determined set of two or more candidate session servers, creating an active registration for the client after (or perhaps in response to) receiving a registration request from the client.

Some embodiments additionally include, after creating an active registration for the client at step 406, renewing the active registration on a periodic or semi-periodic basis at each session server in the set of two or more session servers with which the client has an active registration. In operation, renewing the active registrations includes one or more of the same (or similar) steps performed to create the active registration in the first instance.

For example, in some instances, renewing an active registration includes (i) receiving a renewal request from the client, (ii) determining whether a current response time is below the threshold response time, and (iii) renewing (or maintaining) the active registration when the current response time is below the threshold response time. Some embodiments may additionally include declining to maintain the active registration (or deactivating the registration) when the current response time is above the threshold response time.

In some embodiments, method 400 additionally includes step 408, which includes after the application server has received a request to establish a communication session with a client, determining a set of two or more session servers with which the client has an active registration. In operation, establishing the communication session with the client enables the client to exchange transactions relating to an application such as a file transfer, a database query, remote desktop service, streaming media, interactive sessions (e.g., voice, messaging, video), or any other type of application now known or later developed.

In an example where the application is an interactive video session, the request received by the cloud computing system may be a request to establish the video call. In another example where the application is a file transfer, the request received by the cloud computing system may be a request to open an file transfer protocol (FTP) connection. In yet another example where the request is a database query, the request received by the cloud computing system may be a database query addressed to the target client.

In operation, the application server (e.g., application server 260) receives a request to establish a communication session with a target entity for the communication session relating to an application, e.g., where an initiating entity sends the request to the application server seeking to establish a communication session with the client (i.e., the target entity). The initiating entity (sometimes referred to a calling party) may be (i) another client served by the cloud computing system 200 or (ii) a computing device or application that is not served by the cloud computing system that sends the request to the cloud computing system from the Internet 280 via link 282.

For example if the application server (e.g., application server 260) receives a request to establish a communication session with client 208, the initiating entity may be (i) client 210 which is served by the cloud computing system 200 or (ii) some other computing device or entity reachable via the Internet 280.

In some embodiments, determining a set of two or more session servers with which the client has an active registration at step 408 includes: (i) querying a registry that includes a list of clients having at least one active registration with at least one session sever; and (ii) in response to the query, receiving the set of two or more session servers with which the client has an active registration. Some such embodiments additionally include maintaining the registry (e.g., at the registration/session management server 270).

Next, method 400 advances to step 410, which includes for each session server of the set of two or more session servers with which the client has an active registration, determining a response time between the client and the session server.

In some embodiments, for each session server of the set of two or more session servers with which the client has an active registration, determining a response time between the client and the session server at step 410 includes measuring the response time between the client and each session server with which the client has an active registration after (or perhaps in response to) receiving the request to establish the communication session with the client at step 408.

Next, method 400 advances to step 412, which includes establishing the communication session with the client via the session server having the shortest response time of the set of two or more session servers with which the client has an active registration.

In some embodiments, establishing the communication session with the client via the session server having the shortest response time of the set of two or more session servers with which the client has an active registration at step 412 includes (i) sending, from the application server to each session server in the set of two or more session servers with which the client has an active registration, a request to establish the communication session, (ii) at each session server in the set of two or more session servers with which the client has an active registration, sending, from the session server to the client, a set up request for the communication session, and (iii) establishing the communication session with the client via the first session server from which the application server receives a response to the set up request for the communication session.

In some embodiments, establishing the communication session with the client via the session server having the shortest response time of the set of two or more session servers with which the client has an active registration at step 412 includes for each session server of the set of two or more session servers with which the client has an active registration, determining a response time between the client and the session server by querying an active registration response time table (e.g., maintained by the registration/session management server 270) to determine which active registration has the shortest current response time. Accordingly, such embodiments also include maintaining the active registration response time table (e.g., by the registration/session management server 270), wherein the active registration response time table comprises, for each active registration between a client and a session server, a current response time between the client and the session server. In operation, the response times are measured on a periodic or semi-periodic basis, and the active registration response time table is updated with the measured responses.

In some embodiments, establishing the communication session with the client via the session server having the shortest response time of the set of two or more session servers with which the client has an active registration at step 412 includes measuring the response times for each active registration between the client and a session server after the cloud computing system has received the request to establish the communication session with the client, and then establishing the communication session with the client via the session server that had the shortest response time.

Next, method 400 advances to step 414, which includes after establishing the communication session with the client via the session server having the shortest response time of the set of two or more session servers with which the client has an active registration at step 412, monitoring one or more performance metrics of the communication session. For example, for a communication session established for application 120 between client 208 and session server 204, one or both of session server 204 or session manager 220 (at client 208), individually or in combination, may monitor one or more performance metrics of the communication session. The performance metrics may include any one or more (or all) of (i) an operational status (e.g., communication session up or communication session down), (ii) network congestion on the link 232 between the client 208 and the session server 204, (iii) network latency, (iv) processor load at the session server 204, (v) transaction backlog at the session server 204, (vi) changes in network latency and/or congestion over time, and/or (vii) changes processor load or transaction backlog at the session server 204 over time, individually or in combination with any other operational networking and/or processing metric now known or later developed.

Next, method 400 advances to step 416, which includes when one or more of the performance metrics of the communication session exceeds a corresponding performance threshold, transitioning the communication session to a different session server with which the client has an active registration.

In some embodiments, transitioning the communication session to a different session server (i.e., a second session server) with which the client has an active registration at step 416 also includes establishing a new communication session via the second session server if the client does not already have an active communication session with that second session server.

FIG. 5 shows aspects of an example method 500 according to some embodiments. In some embodiments, method 500 is performed by a client running a network-based application provided by a cloud computing system, such as any of the clients 208 and 210 running network-based applications 120 and 122, respectively, provided by cloud computing system 200.

Method 500 begins at step 502, which includes establishing an active registration for the client at two or more session servers of the cloud computing system, where each session server is configured to control one or more aspects of a communication session for an application associated with an application server. Some embodiments additionally include, for each session server in the set of two or more session servers with which the client has an active registration, renewing the active registration for the client on a periodic or semi-periodic basis. In operation, establishing and renewing active registrations may be performed in the same (or similar) manner as described with reference to steps 402-406.

Next, method 500 advances to step 504, which includes, for each session server in a set of two or more session servers with which the client has an active registration, determining a current response time between the session server and the client.

In some embodiments of method 500, the client additionally maintains an active registration response time table at the client. The active registration response time table comprises, for each active registration between the client and a session server, a current response time between the client and the session server. In some such embodiments, determining a current response time between the session server and the client for each session server in the set of two or more session servers with which the client has an active registration at step 504 includes the client querying the active registration response time table at the client to determine which active registration has the shortest current response time.

In other embodiments, an active registration response time table is maintained by the cloud computing system (e.g., registration/session management server 270). In some such embodiments, determining a current response time between the session server and the client for each session server in the set of two or more session servers with which the client has an active registration at step 504 includes the client querying the active registration response time table at the cloud computing system (e.g., registration/session management server 270) to determine which active registration has the shortest current response time.

Next, method 500 advances to step 506, which includes, after the client has received a request to establish a communication session for the application associated with the application server, establishing the communication session for the application associated with the application server via the session server having the shortest response time of the set of two or more session servers with which the client has an active registration.

In some embodiments, the client receives the request to establish the communication session via one of the user interfaces of the client (e.g., user interfaces 358 of client 350). For example, the request to establish the communication session may correspond to a request received via the user interface to start a remote desktop session on the client, initiate an interactive voice or video call, perform a file transfer or database query, or similar.

In some embodiments, establishing the communication session for the application associated with the application server via the session server having the shortest response time of the set of two or more session servers with which the client has an active registration at step 506 includes (i) sending, from the client to each session server in the set of two or more session servers with which the client has an active registration, a request to establish the communication session, and (ii) establishing the communication session via the first session server from which the client receives a response to the set up request for the communication session.

In operation, establishing the communication session enables the client to exchange transactions relating to the application. As mentioned previously, examples of applications include file transfers, database queries, remote desktop services, streaming media, interactive sessions (e.g., voice, messaging, video), or any other type of application now known or later developed.

In the context of method 500, the client request to establish the communication session corresponds to a scenario where the client is the initiating entity and some other client or device is the target entity. For example, the client request to establish the communication session may correspond to a request received by the client (e.g., client 208) via the user interface of the client (e.g., user interface 358) to establish an interactive video session with (i) a target entity served by the cloud computing system 200 (e.g., client 210) or (ii) a target entity not served by the cloud computing system 200 but that is reachable via the link 282 to the Internet 280. In another example, the client request to establish the communication session may correspond to a request received by the client (e.g., client 208) via the user interface of the client (e.g., user interface 358) to establish a remote desktop session with the application server 260.

Next, method 500 advances to step 508, which includes, after establishing the communication session for the application associated with the application server via the session server having the shortest response time of the set of two or more session servers with which the client has an active registration, monitoring one or more performance metrics of the communication session. For example, and as described earlier, for a communication session established for application 120 between client 208 and session server 204, one or both of session server 204 or session manager 220 (at client 208), individually or in combination, may monitor one or more performance metrics of the communication session. The performance metrics may include any one or more (or all) of (i) an operational status (e.g., communication session up or communication session down), (ii) network congestion on the link 232 between the client 208 and the session server 204, (iii) network latency, (iv) processor load at the session server 204, (v) transaction backlog at the session server 204, (vi) changes in network latency and/or congestion over time, and/or (vii) changes processor load or transaction backlog at the session server 204 over time, individually or in combination with any other operational networking and/or processing metric now known or later developed.

Next, method 500 advances to step 510, which includes, when one or more of the performance metrics of the communication session exceeds a corresponding performance threshold, transitioning the communication session to a different session server with which the client has an active registration. In some embodiments, transitioning the communication session to a different session server (e.g., a second session server) with which the client has an active registration at step 510 also includes establishing a new communication session via the second session server if the client does not already have an active communication session with that second session server.

Some embodiments of method 500 additionally include the client transmitting a registration inquiry to the cloud computing system to establish an active registration with one or more session servers. In one example, transmitting the registration inquiry to the cloud computing system includes the client 208 transmitting the registration inquiry to at least one of the application server 260 or the registration/session management server 270. In other examples, transmitting the registration inquiry to the cloud computing system may include the client 208 transmitting the registration inquiry to another component of the cloud computing system that is configured to process registration inquiries received from clients.

In some embodiments, the cloud computing system (in response to the registration inquiry) sends the client an identification of a plurality of available session servers for the client to establish an active registration with. In some such embodiments, after receiving, from the cloud computing system, the identification of the plurality of available session servers for the client to establish an active registration with, method 500 additionally includes the client establishing the active registration at two or more of the two or more session servers of the plurality of available session servers.

In some embodiments, establishing an active registration for the client at two or more of the two or more session servers of the plurality of available session servers includes (i) for each of the plurality of available session servers in the cloud computing system, determining a response time between the available session server and the client, and (ii) establishing an active registration with two or more session servers having a determined response time below a threshold response time. In some embodiments, the response time is based on any one or more of network latency between the client and the session server, network latency between an application server and the session server, or processing time at the session server.

The ordering of the method steps in methods 400 and 500 shown in FIGS. 4 and 5 are for ease of illustration. Methods 400 and 500 do not require a specific sequence of steps. Additionally, not all steps need to be performed every time aspects of methods 400 and 500 are executed. The method steps shown and described with reference to FIGS. 4 and 5 can be performed in any order, some steps may be skipped, and different combinations of steps can be implemented based on the specific requirements of the application and situation.

### D. CONCLUSIONS

The above discussions relating to cloud computing systems and clients provide only some examples of operating environments, devices, and systems within which functions and methods described herein may be implemented. Other operating environments and configurations of network devices and systems not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of the disclosed systems and methods. The appearances of this phrase in various places in the specification are not necessarily all referring to the same embodiment, nor are separate or alternative example configurations mutually exclusive of other example configurations. As such, the example configurations described herein, explicitly and implicitly understood by one skilled in the art, can be combined with other example configurations.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the disclosed systems and methods. However, it is understood to those skilled in the art that certain example configurations of the present disclosure can be practiced without certain, specific details. In other instances, well known methods, procedures, components, and circuitry have not been described in detail to avoid unnecessarily obscuring aspects of the example configurations. Accordingly, the scope of the present disclosure is defined by the appended claims rather than the foregoing description of example configurations.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

What is claimed is:

1. A method implemented by a cloud computing system comprising an application server and a plurality of session servers, the method comprising:
after the application server has received a request to establish a communication session with a client, determining a set of two or more session servers with which the client has an active registration;
for each session server of the set of two or more session servers with which the client has an active registration, determining a response time between the client and the session server; and
establishing the communication session with the client via the session server having the shortest response time of the set of two or more session servers with which the client has an active registration.

2. The method of claim 1, wherein establishing the communication session with the client via the session server having the shortest response time of the set of two or more session servers with which the client has an active registration comprises:
sending, from the application server to each session server in the set of two or more session servers with which the client has an active registration, a request to establish the communication session;
at each session server in the set of two or more session servers with which the client has an active registration, sending, from the session server to the client, a set up request for the communication session; and
establishing the communication session with the client via the first session server from which the application server receives a response to the set up request for the communication session.

3. The method of claim 1, wherein the method further comprises:
maintaining an active registration response time table, wherein the active registration response time table comprises, for each active registration between a client and a session server, a current response time between the client and the session server; and
wherein, for each session server of the set of two or more session servers with which the client has an active registration, determining a response time between the client and the session server comprises querying the active registration response time table to determine which active registration has the shortest current response time.

4. The method of claim 1, further comprising:
maintaining a registry comprising a list of clients having at least one active registration with at least one session server; and
wherein determining a set of two or more session servers with which the client has an active registration comprises: (i) querying the registry; and (ii) in response to the query, receiving the set of two or more session servers with which the client has an active registration.

5. The method of claim 1, further comprising:
after receiving a registration inquiry from a client, determining a set of two or more candidate session servers for the client to establish an active registration with;
sending the client an identification of each candidate session server in the determined set of two or more candidate session servers; and
at each candidate session server in the determined set of two or more candidate session servers, after receiving a registration request from the client, creating an active registration for the client.

6. The method of claim 5, wherein determining a set of two or more candidate session servers for the client to register with comprises:
for each of a plurality of available session servers in the cloud computing system, determining a response time between the available session server and the client;
including available session servers having a determined response time below a threshold response time in the set of two or more candidate session servers; and
excluding any available session server having a determined response time above the threshold response time from the set of two or more candidate session servers.

7. The method of claim 6, wherein the response time is based on any one or more of network latency between the client and the session server, network latency between the application server and the session server, or processing time at the session server.

8. The method of claim 1, further comprising:
at each session server in the set of two or more session servers with which the client has an active registration, renewing the active registration on a periodic or semi-periodic basis.

9. The method of claim 1, wherein the communication session comprises at least one of a file transfer, a database query, a streaming media session, a voice communication session, a video communication session, or a messaging communication session.

10. The method of claim 1, wherein the method further comprises:
after establishing the communication session with the client via the session server having the shortest response time of the set of two or more session servers with which the client has an active registration, monitoring one or more performance metrics of the communication session; and
when one or more of the performance metrics of the communication session exceeds a corresponding performance threshold, transitioning the communication session to a different session server with which the client has an active registration.

11. A method executed at a client, the method comprising:
establishing an active registration for the client at two or more session servers of a cloud computing system, wherein each session server is configured to control one or more aspects of a communication session for an application associated with an application server;
for each session server in a set of two or more session servers with which the client has an active registration, determining a current response time between the session server and the client; and
after the client has received a request to establish a communication session for the application associated with the application server, establishing the communication session for the application associated with the application server via the session server having the shortest response time of the set of two or more session servers with which the client has an active registration.

12. The method of claim 11, wherein establishing the communication session for the application associated with the application server via the session server having the shortest response time of the set of two or more session servers with which the client has an active registration comprises:
sending, from the client to each session server in the set of two or more session servers with which the client has an active registration, a request to establish the communication session; and
establishing the communication session via the first session server from which the client receives a response to the set up request for the communication session.

13. The method of claim 11, wherein the method further comprises:
maintaining an active registration response time table at the client, wherein the active registration response time table comprises, for each active registration between the client and a session server, a current response time between the client and the session server; and
wherein, for each session server of the set of two or more session servers with which the client has an active registration, determining a current response time between the session server and the client comprises querying the active registration response time table to determine which active registration has the shortest current response time.

14. The method of claim 11, further comprising:
transmitting, from the client to a cloud computing system, a registration inquiry; and
after receiving, from the cloud computing system, an identification of a plurality of available session servers for the client to establish an active registration with, establishing the active registration for the client at two or more of the two or more session servers of the plurality of available session servers.

15. The method of claim 14, wherein establishing an active registration for the client at two or more of the two or more session servers of the plurality of available session servers comprises:
for each of the plurality of available session servers in the cloud computing system, determining a response time between the available session server and the client;
establishing an active registration with two or more session servers having a determined response time below a threshold response time.

16. The method of claim 15, wherein the response time is based on any one or more of network latency between the client and the session server, network latency between an application server and the session server, or processing time at the session server.

17. The method of claim 1, further comprising:
for each session server in the set of two or more session servers with which the client has an active registration, renewing the active registration for the client on a periodic or semi-periodic basis.

18. The method of claim 11, wherein the communication session comprises at least one of a file transfer, a database query, a streaming media session, a voice communication session, a video communication session, or a messaging communication session.

19. The method of claim 11, wherein the method further comprises:
after establishing the communication session for the application associated with the application server via the session server having the shortest response time of the set of two or more session servers with which the client has an active registration, monitoring one or more performance metrics of the communication session; and
when one or more of the performance metrics of the communication session exceeds a corresponding performance threshold, transitioning the communication session to a different session server with which the client has an active registration.

20. Tangible, non-transitory computer-readable media having program instructions stored therein, wherein the program instructions, when executed by one or more processors of a client device, cause the client device to perform a method comprising:
establishing an active registration for the client at two or more session servers of a cloud computing system, wherein each session server is configured to control one or more aspects of a communication session for an application associated with an application server;
for each session server in a set of two or more session servers with which the client has an active registration, determining a current response time between the session server and the client; and
after the client has received a request to establish a communication session for the application associated with the application server, (i) for each session server in a set of two or more session servers with which the client has an active registration, determining a current response time between the session server and the client, and (ii) establishing the communication session for the application associated with the application server via the session server having the shortest response time of the set of two or more session servers with which the client has an active registration.
